(19) United States
(12) Patent Application Publication
(10) Pub. No.: US 2026/0249734 A1
(43) Pub. Date: Aug. 27, 2026

(54) CHARGING SUPPORT SYSTEM AND CHARGING SUPPORT METHOD

(71) Applicant: Panasonic Automotive Systems Co., Ltd., Kanagawa (JP)

(72) Inventors: Akihito TAKEUCHI, Osaka (JP); Takumaru NAGAI, Osaka (JP); Tomohisa SEZAKI, Kanagawa (JP)

(73) Assignee: Panasonic Automotive Systems Co., Ltd., Kanagawa (JP)

(21) Appl. No.: 19/445,042

(22) Filed: Jan. 9, 2026

(30) Foreign Application Priority Data
Feb. 26, 2025 (JP) 2025-029366

(51) Int. Cl. B60L 53/65; B60L 53/30; B60L 53/68; H04L 9/40

(52) U.S. Cl. CPC B60L 53/65; B60L 53/305; B60L 53/68; H04L 63/10; H04L 63/1441; B60L 2240/70; B60L 2250/16; B60L 2270/38

(57) ABSTRACT

Charging support system includes: log receiver that receives a log sent from a vehicle or charging equipment; risk value calculator that, based on the log, determines whether a cyberattack has occurred in the vehicle or the charging equipment; blacklist generator that, when a cyberattack is determined to have occurred in the vehicle or the charging equipment, generates communication information indicating a communication method through which the cyberattack will not spread from the vehicle where the cyberattack has occurred, or a communication method through which the cyberattack will not spread from the charging equipment where the cyberattack has occurred; and blacklist distributor that outputs the communication information.

### CROSS REFERENCE TO RELATED APPLICATION

The present application is based on and claims priority of Japanese Patent Application No. 2025-029366 filed on Feb. 26, 2025.

### FIELD

The present disclosure relates to a charging support system and a charging support method that support the charging of a vehicle.

### BACKGROUND

Patent Literature (PTL) 1 discloses a system that takes a current charge level into account and, if charging will be necessary to reach a destination from a current location, detects a route to charging equipment along the way, generates a schedule, and sends the route and schedule to the vehicle and the charging equipment.

PTL 2 discloses a system that detects whether a malfunction such as a power outage has occurred at a charging station and proposes nearby charging equipment to a vehicle in accordance with whether such a malfunction has occurred.

### Citation List

### Patent Literature

PTL 1: International Publication No. 2014/033944

PTL 2: Japanese Unexamined Patent Application Publication No. 2012-53821

### SUMMARY

The systems disclosed in PTL 1 and PTL 2 can be improved upon.

Accordingly, the present disclosure provides a charging support system and the like capable of improving upon the above related art.

A charging support system according to the present disclosure includes: a log receiver that receives a log sent from a vehicle or charging equipment; an attack determiner that, based on the log, determines whether a cyberattack has occurred in the vehicle or the charging equipment; a generator that, when a cyberattack is determined to have occurred in the vehicle or the charging equipment, generates communication information indicating a communication method through which the cyberattack will not spread from the vehicle where the cyberattack has occurred, or a communication method through which the cyberattack will not spread from the charging equipment where the cyberattack has occurred; and an outputter that outputs the communication information.

A charging support method according to the present disclosure includes: receiving a log sent from a vehicle or charging equipment; determining, based on the log, whether a cyberattack has occurred in the vehicle or the charging equipment; when a cyberattack is determined to have occurred in the vehicle or the charging equipment, generating communication information indicating a communication method through which the cyberattack will not spread from the vehicle where the cyberattack has occurred, or a communication method through which the cyberattack will not spread from the charging equipment where the cyberattack has occurred; and outputting the communication information.

Note that these comprehensive or specific aspects may be realized by a system, a method, an integrated circuit, a computer program, or a computer-readable recording medium such as a CD-ROM, or may be implemented by any desired combination of systems, devices, methods, integrated circuits, computer programs, and recording media.

According to the charging support system and the like according to an aspect of the present disclosure, the above related art can be further improved upon.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram illustrating an example of a charging support system according to Embodiment 1.

FIG. 2 is a flowchart illustrating an example of operations by the charging support system according to Embodiment 1.

FIG. 3 is a diagram illustrating operations by the charging support system according to Embodiment 1.

FIG. 4 is a block diagram illustrating an example of a charging support system according to Embodiment 2.

FIG. 5 is a flowchart illustrating an example of operations by the charging support system according to Embodiment 2.

FIG. 6 is a diagram illustrating operations by the charging support system according to Embodiment 2.

FIG. 7 is a flowchart illustrating an example of a charging support method according to another embodiment.

### DESCRIPTION OF EMBODIMENTS

However, the techniques disclosed in PTL 1 and PTL 2 do not take into account whether a cyberattack has occurred in the vehicle or in the charging equipment. There is thus a risk that personal information will be leaked or the vehicle will be infected with malware if charging equipment where a cyberattack has occurred communicates with the vehicle. There is also a risk that threats will spread to the charging equipment, and by extension to other vehicles as well, if a vehicle where a cyberattack has occurred communicates with the charging equipment. Hereinafter, a charging support system and the like capable of suppressing the spread of cyberattacks when charging a vehicle from charging equipment will be described.

Embodiments will be described in detail hereinafter with reference to the drawings.

Note that the following embodiments describe comprehensive or specific examples of the disclosure. The numerical values, shapes, materials, constituent elements, arrangements and connection states of constituent elements, steps, orders of steps, and the like in the following embodiments are merely examples, and are not intended to limit the present disclosure.

### Embodiment 1

A charging support system according to Embodiment 1 will be described hereinafter.

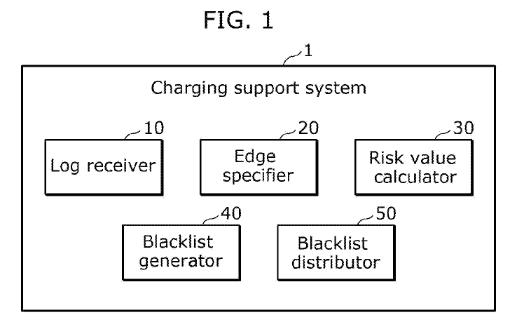

FIG. 1 is a block diagram illustrating an example of charging support system 1 according to Embodiment 1.

Charging support system 1 is a system for supporting charging from charging equipment such as a charging station to a vehicle. The vehicle is an electric vehicle (a Battery Electric Vehicle (BEV)), for example. The charging equipment is equipment that charges over wires, equipment that charges wirelessly, or a dynamic power supply system, for example. In the following, the vehicle or the charging equipment will also be referred to as an “edge”. Charging support system 1 may be a Security Operation Center (SOC) that collects logs from edges, or an E-mobility Provider that manages charging equipment.

Charging support system 1 includes log receiver 10, edge specifier 20, risk value calculator 30, blacklist generator 40, and blacklist distributor 50. Charging support system 1 is a computer including a processor (microprocessor), a memory, and the like. The memory is a read-only memory (ROM), a random access memory (RAM), and the like, which can store the programs executed by the processor. Log receiver 10, edge specifier 20, risk value calculator 30, blacklist generator 40, and blacklist distributor 50 are implemented by the processor and the like, which execute programs stored in the memory. Charging support system 1 is a server, for example. Note that the constituent elements provided in charging support system 1 may be provided in a single server, or may be distributed throughout a plurality of servers.

Log receiver 10 receives a log sent from an edge.

Edge specifier 20 specifies the edge that generated the log based on the log received by log receiver 10.

Risk value calculator 30 determines whether a cyberattack has occurred in the edge specified by edge specifier 20 based on the log received by log receiver 10. Risk value calculator 30 is an example of an “attack determiner”. For example, when a cyberattack is determined to have occurred, risk value calculator 30 calculates a risk value indicating the magnitude of the risk the cyberattack poses to other vehicles or other charging equipment. Operations by risk value calculator 30 will be described in detail later.

When a cyberattack is determined to have occurred at the edge specified by edge specifier 20, blacklist generator 40 generates communication information indicating a communication method through which the cyberattack will not spread from the vehicle where the cyberattack occurred, or a communication method through which the cyberattack will not spread from the charging equipment where the cyberattack occurred. In other words, blacklist generator 40 generates communication information indicating a communication method through which the cyberattack will not spread from the edge where the cyberattack occurred. Blacklist generator 40 is an example of a “generator”.

For example, the communication information is information indicating a communication method that prohibits communication between the vehicle where the cyberattack has occurred and charging equipment that charges that vehicle, or communication between the charging equipment where the cyberattack has occurred and a vehicle charged by that charging equipment. Specifically, the communication information is a blacklist of edges with which communication is to be prohibited, the blacklist including a vehicle where a cyberattack has occurred or charging equipment where a cyberattack has occurred. Operations by blacklist generator 40 will be described in greater detail later.

Blacklist distributor 50 outputs the communication information (specifically, the blacklist) generated by blacklist generator 40. Blacklist distributor 50 is an example of an outputter.

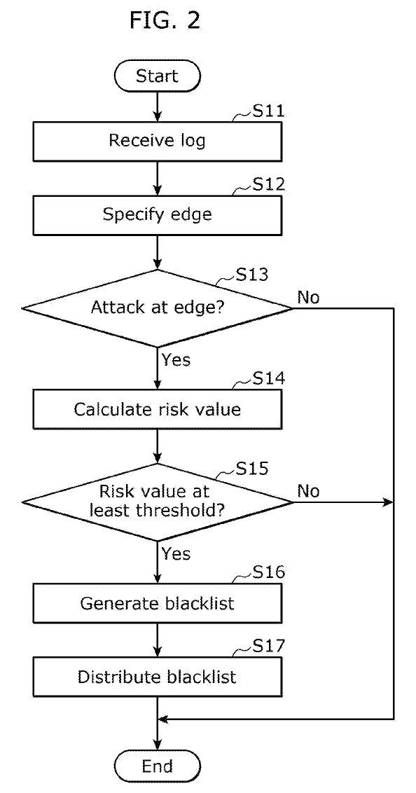

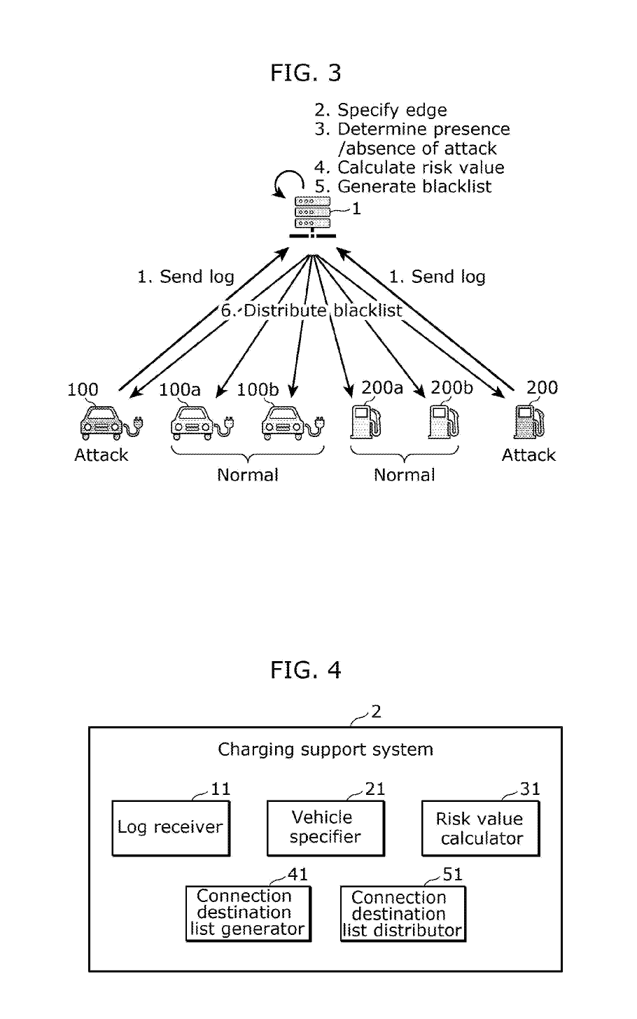

Operations by charging support system 1 will be described in detail next with reference to FIGS. 2 and 3.

FIG. 2 is a flowchart illustrating an example of operations by charging support system 1 according to Embodiment 1.

FIG. 3 is a diagram illustrating operations by charging support system 1 according to Embodiment 1.

First, log receiver 10 receives the log sent from the edge (step S11). For example, as illustrated in FIG. 3, log receiver 10 receives logs from vehicles 100 and charging equipment 200. The log includes information identifying the sender, transmission date/time information (a timestamp), current location information, communication logs and attack detection results, and the like, for example. Although the timing at which the log is sent from the edge is not particularly limited, the log may be sent when an attack is detected at the edge, every predetermined period, when the log is requested by charging support system 1, or the like, for example.

Next, edge specifier 20 uses the information included in the log sent from the edge to specify the edge that generated the log (step S12). For example, as illustrated in FIG. 3, edge specifier 20 specifies vehicles 100 and charging equipment 200 as the edges that generated the logs using the information included in the logs sent from the edges.

Next, risk value calculator 30 determines whether a cyberattack has occurred at the edge using the information included in the log sent from the edge (step S13). For example, when an attack detection is performed at an edge, a log including an attack detection result is sent to charging support system 1, and the attack detection result included in the log indicates that a cyberattack has occurred at the edge, risk value calculator 30 can determine that a cyberattack has occurred at the edge. Note that charging support system 1 may detect an attack using communication data included in the log received from the edge, and when a cyberattack at the edge is detected from the communication data, risk value calculator 30 can determine that a cyberattack has occurred at the edge. In this manner, risk value calculator 30 determines whether a cyberattack has occurred at the edge based on the log sent from the edge, but the attack detection itself may be performed by the edge or by charging support system 1.

If risk value calculator 30 determines that a cyberattack has not occurred at the edge (NO in step S13), the processing ends.

If a cyberattack is determined to have occurred at the edge (YES in step S13), risk value calculator 30 calculates a risk value indicating the magnitude of the risk the cyberattack poses to other vehicles or other charging equipment (step S14). For example, as illustrated in FIG. 3, risk value calculator 30 determines that a cyberattack has occurred in vehicles 100 and charging equipment 200, and calculates a risk value indicating the magnitude of the risk the cyberattack poses to vehicle 100a or 100b or charging equipment 200a or 200b. The method for calculating the risk value will be described below, but for example, a risk value of 1 is assumed to indicate the lowest risk, and a risk value of 5 is assumed to indicate the highest risk.

Risk value calculator 30 may calculate the risk value based on the details of the attack that occurred at the edge (i.e., the type of the attack), for example. Specifically, risk value calculator 30 calculates a risk value of 1 when the attack is a port scan or a brute force attack, calculates a risk value of 2 when the attack is an unauthorized login, calculates a risk value of 3 when the attack is an unauthorized message transmission, calculates a risk value of 4 when the attack is a malware download, and calculates a risk value of 5 when the attack is a tampering with firmware or inputting a higher level of power than a prescribed level. For example, risk value calculator 30 may calculate the risk value using a table or the like associating attack details and risk values with each other.

Risk value calculator 30 may calculate the risk value based on the location where the attack is occurring in the edge (i.e., the depth), for example. “Depth” refers to the depth of the location where the attack occurred, assuming the entry point of the attack on the edge being taken as the starting point. An attack occurring deeper from the entry point increases the chance that the edge will be completely taken over. For example, assume that the depth from the entry point increases in order from a telematics electronic control unit (ECU), an In-Vehicle Infotainment (IVI) ECU, a gateway ECU, an Advanced Driver Assistance System (ADAS) ECU, and a control system ECU. Specifically, risk value calculator 30 calculates a risk value of 1 when an attack is occurring in the telematics ECU, calculates a risk value of 2 when an attack is occurring in the IVI ECU, calculates a risk value of 3 when an attack is occurring in the gateway ECU, calculates a risk value of 4 when an attack is occurring in the ADAS ECU, and calculates a risk value of 5 when an attack is occurring in the control system ECU. For example, risk value calculator 30 may calculate the risk value using a table or the like associating attack locations and risk values with each other.

Risk value calculator 30 may calculate the risk value based on an estimated time required for the edge to be completely taken over, for example. Specifically, risk value calculator 30 calculates a risk value of 1 when the estimated time is longer than one week, calculates a risk value of 2 when the estimated time is one week or less, calculates a risk value of 3 when the estimated time is three days or less, calculates a risk value of 4 when the estimated time is 24 hours or less, and calculates a risk value of 5 when the estimated time is 12 hours or less. For example, risk value calculator 30 may calculate the risk value using a table or the like associating estimated times required for the edge to be completely taken over and risk values with each other.

Note that risk value calculator 30 may calculate the risk value based on at least two items among the details of the attack that occurred at the edge, the location where the attack is occurring at the edge, and the estimated time required for the edge to be completely taken over.

Next, risk value calculator 30 determines whether the calculated risk value is at least a preset threshold (step S15). The threshold is not particularly limited and is set as appropriate.

If risk value calculator 30 determines that the calculated risk value is less than the preset threshold (NO in step S15), the processing ends. If the risk value of the cyberattack is low, it is unlikely to be a problem even if the cyberattack spreads, and communication information (described later; the blacklist, in Embodiment 1) is therefore not generated. In other words, if the risk value is low, a charging service can be provided as normal.

If risk value calculator 30 determines that the calculated risk value is at least the preset threshold (YES in step S15), blacklist generator 40 generates communication information (the blacklist, in Embodiment 1) (step S16). The blacklist includes information specifying the edge where the cyberattack occurred (e.g., vehicle 100 and charging equipment 200), such as an identification number, an edge name, a software version, or the like. The blacklist may also include factors of the cyberattack.

Blacklist distributor 50 then distributes the blacklist generated by blacklist generator 40 to the edge (step S17). For example, blacklist distributor 50 may distribute the blacklist through a broadcast. This enables normal vehicles 100a and 100b and charging equipment 200a and 200b to receive the blacklist, as illustrated in FIG. 3.

Note that blacklist distributor 50 may output the blacklist to the edge when the edge makes a request for the blacklist. Through this, an edge to which the blacklist has not been distributed can obtain the blacklist by making a request for the blacklist to charging support system 1, for example.

Alternatively, blacklist distributor 50 may output the blacklist to an edge present in the vicinity of the vehicle where the cyberattack has occurred or the charging equipment where the cyberattack has occurred. For example, based on the current location information included in the log, blacklist distributor 50 can distribute the blacklist only to edges present in the vicinity of the edge where the cyberattack occurred. Outputting the blacklist to edges in the vicinity of the edge where the cyberattack has occurred, and to which the cyberattack is therefore likely to spread, makes it possible to suppress the spread of the cyberattack to those edges.

Blacklist distributor 50 may also output information indicating charging equipment not included in the blacklist, for example. Through this, information indicating charging equipment not included in the blacklist, i.e., charging equipment where a cyberattack has not occurred, is also output, which enables vehicles to charge using normal charging equipment.

Blacklist distributor 50 may also display the blacklist on a display device, for example. Specifically, blacklist distributor 50 may output the blacklist not only to the edges, but also to a smartphone or a car navigation system to be displayed therein. This enables occupants of the vehicle, an administrator of the charging equipment, or the like to check the blacklist. For example, the smartphone or the car navigation system can display the location or an identification number of a vehicle that should not be charged or charging equipment that should not be used for charging, display the date/time when an attack occurred, or the like.

As described above, communication information indicating a communication method through which the cyberattack will not spread (e.g., the blacklist) is generated and distributed to the edges managed by charging support system 1. Accordingly, edges that obtain the communication information can charge using the communication method through which the cyberattack will not spread. The spread of cyberattacks can therefore be suppressed when charging a vehicle from charging equipment. For example, communication between a vehicle where a cyberattack has occurred and charging equipment that charges that vehicle, or communication between charging equipment where a cyberattack has occurred and a vehicle charged by that charging equipment, is prohibited, and the spread of the cyberattack can therefore be suppressed. At this time, using a blacklist of vehicles or charging equipment makes it possible to ensure that communication between a vehicle where a cyberattack has occurred and charging equipment that charges that vehicle, or communication between charging equipment where a cyberattack has occurred and a vehicle charged by that charging equipment, is not performed.

For example, blacklist generator 40 may add another vehicle or other charging equipment to the blacklist based on an attack occurrence time (e.g., log transmission date/time information) or an attack factor (e.g., an edge that is the source of the attack) indicated by a log obtained from a vehicle where a cyberattack has occurred or charging equipment where a cyberattack has occurred. For example, if, based on the log transmission date/time information, the current location information, or charging history information (information indicating which vehicle used which charging equipment) included in the log obtained from the vehicle where the cyberattack has occurred or the charging equipment where the cyberattack has occurred, blacklist generator 40 has successfully determined that a cyberattack has also occurred at a location aside from the edge that transmitted the log, edges presumed to have been affected can be added to the blacklist in bulk. Additionally, if, for example, blacklist generator 40 has successfully specified an edge that is the source of an attack, that edge can be added to the blacklist.

For example, when charging a vehicle, charging equipment may inquire with charging support system 1 as to whether the vehicle is on the blacklist, and charging support system 1 may respond to the charging equipment as to whether the vehicle is on the blacklist.

For example, if a vehicle on the blacklist has come to charge using the charging equipment, the charging equipment may notify the SOC or the like to that effect. For example, if a vehicle on the blacklist has come to charge using the charging equipment, the charging equipment may avoid communicating with the vehicle. Additionally, for example, if an occupant of the vehicle is attempting to charge using charging equipment on the blacklist, the vehicle may avoid communicating with the charging equipment.

### Embodiment 2

A charging support system according to Embodiment 2 will be described hereinafter.

FIG. 4 is a block diagram illustrating an example of charging support system 2 according to Embodiment 2.

Like charging support system 1 according to Embodiment 1, charging support system 2 is a system for supporting charging from charging equipment to a vehicle. In the following, points that are the same as in charging support system 1 according to Embodiment 1 will not be described, and the descriptions will focus on the differences.

Charging support system 2 includes log receiver 11, vehicle specifier 21, risk value calculator 31, connection destination list generator 41, and connection destination list distributor 51. Charging support system 2 is a computer including a processor (microprocessor), a memory, and the like. The memory is a ROM, a RAM, and the like, which can store the programs executed by the processor. Log receiver 11, vehicle specifier 21, risk value calculator 31, connection destination list generator 41, and connection destination list distributor 51 are implemented by the processor and the like, which execute programs stored in the memory. Charging support system 2 is a server, for example. Note that the constituent elements provided in charging support system 2 may be provided in a single server, or may be distributed throughout a plurality of servers.

Log receiver 11 receives a log sent from an edge.

Vehicle specifier 21 specifies the edge that generated the log based on the log received by log receiver 11. Note that in Embodiment 2, vehicle specifier 21 specifies the vehicle that generated the log.

Risk value calculator 31 determines whether a cyberattack has occurred in the vehicle specified by vehicle specifier 21 based on the log received by log receiver 11. Risk value calculator 31 is an example of an “attack determiner”. For example, when a cyberattack is determined to have occurred, risk value calculator 31 calculates a risk value indicating the magnitude of the risk the cyberattack poses to other vehicles or other charging equipment. Operations by risk value calculator 31 will be described in detail later.

When a cyberattack is determined to have occurred in the vehicle specified by vehicle specifier 21, connection destination list generator 41 generates communication information indicating a communication method through which the cyberattack will not spread from the vehicle where the cyberattack occurred. Connection destination list generator 41 is an example of a “generator”. For example, the communication information is information indicating a communication method that switches communication from communication between the vehicle where the cyberattack has occurred and a charging management server (e.g., charging support system 2) managing charging equipment that charges that vehicle to communication with another charging management server. Specifically, the communication information is a list of charging management servers, among charging management servers managing charging equipment that charges the vehicle where the cyberattack has occurred, that are capable of connecting to the vehicle where the cyberattack has occurred (called a “connection destination list” hereinafter). Operations by connection destination list generator 41 will be described in greater detail later.

Connection destination list distributor 51 outputs the communication information (specifically, the connection destination list) generated by connection destination list generator 41. Connection destination list distributor 51 is an example of an outputter.

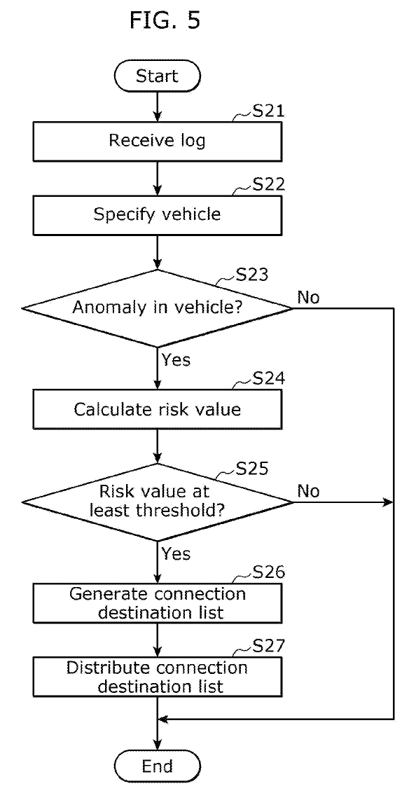

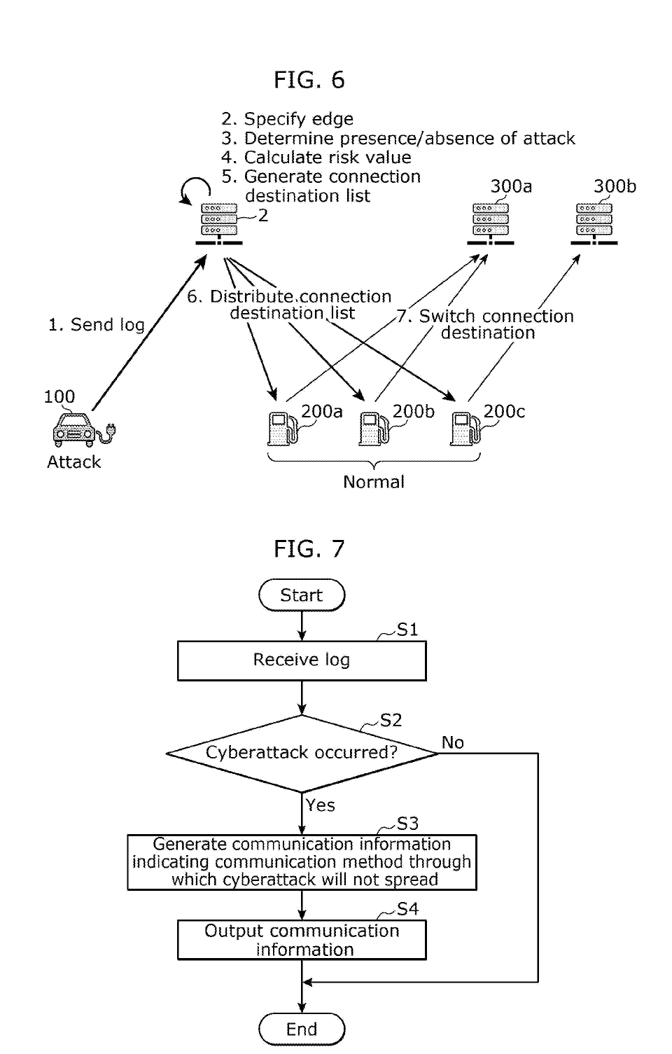

Operations by charging support system 2 will be described in detail next with reference to FIGS. 5 and 6.

FIG. 5 is a flowchart illustrating an example of operations by charging support system 2 according to Embodiment 2.

FIG. 6 is a diagram illustrating operations by charging support system 2 according to Embodiment 2.

First, log receiver 11 receives the log sent from the edge (step S21). For example, as illustrated in FIG. 6, log receiver 11 receives the log from vehicle 100.

Next, vehicle specifier 21 uses the information included in the log sent from the edge to specify the vehicle that generated the log (step S22). For example, as illustrated in FIG. 6, using the information included in the log sent from the edge, vehicle specifier 21 specifies vehicle 100 as the edge that generated the log.

Next, risk value calculator 31 determines whether an anomaly is present in the vehicle (i.e., whether a cyberattack has occurred in the vehicle) using the information included in the log sent from the edge (step S23). For example, when attack detection is performed by a vehicle, a log including an attack detection result is transmitted to charging support system 2, and the attack detection result included in the log indicates that a cyberattack has occurred in the vehicle, risk value calculator 31 can determine that a cyberattack has occurred in the vehicle. Note that charging support system 2 may detect an attack using communication data included in the log received from the vehicle, and when a cyberattack in the vehicle is detected from the communication data, risk value calculator 31 can determine that a cyberattack has occurred in the vehicle. In this manner, risk value calculator 31 determines whether a cyberattack has occurred in the vehicle based on the log transmitted from the vehicle, but the attack detection itself may be performed by the vehicle or by charging support system 2.

If risk value calculator 31 determines that a cyberattack has not occurred in the vehicle (NO in step S23), the processing ends.

If a cyberattack is determined to have occurred in the vehicle (YES in step S23), risk value calculator 31 calculates a risk value indicating the magnitude of the risk the cyberattack poses to other vehicles or other charging equipment (step S24). For example, as illustrated in FIG. 6, risk value calculator 31 determines that a cyberattack has occurred in vehicle 100, and calculates a risk value indicating the magnitude of the risk the cyberattack poses to charging equipment 200a, 200b, or 200c. The method for calculating the risk value is the same as that described in Embodiment 1, and will therefore not be described here.

Next, risk value calculator 31 determines whether the calculated risk value is at least a preset threshold (step S25). The threshold is not particularly limited and is set as appropriate.

If risk value calculator 31 determines that the calculated risk value is less than the preset threshold (NO in step S25), the processing ends. If the risk value of the cyberattack is low, it is unlikely to be a problem even if the cyberattack spreads, and communication information (described later; the connection destination list, in Embodiment 2) is therefore not generated. In other words, if the risk value is low, a charging service can be provided as normal.

If risk value calculator 31 determines that the calculated risk value is at least the preset threshold (YES in step S25), connection destination list generator 41 generates communication information (the connection destination list, in Embodiment 2) (step S26). The connection destination list is, as described above, a list of charging management servers capable of connecting to the vehicle where the cyberattack has occurred, and includes information about, for example, servers having strong security features which do not allow attacks from vehicles to spread, or servers which function as honeypots for collecting information about attacks occurring in vehicles (e.g., information about servers 300a and 300b illustrated in FIG. 6).

Connection destination list distributor 51 then distributes the connection destination list generated by connection destination list generator 41 to the charging equipment (step S27). For example, connection destination list distributor 51 may distribute the connection destination list through a broadcast. This enables normal charging equipment 200a, 200b, and 200c to receive the connection destination list, as illustrated in FIG. 6.

Note that connection destination list distributor 51 may output the connection destination list to the charging equipment when the charging equipment requests the connection destination list. Through this, charging equipment to which the connection destination list has not been distributed can obtain the connection destination list by making a request for the connection destination list to charging support system 2, for example.

Alternatively, connection destination list distributor 51 may output the connection destination list to charging equipment present in the vicinity of the vehicle where the cyberattack has occurred. For example, based on the current location information included in the log, connection destination list distributor 51 can distribute the connection destination list only to the charging equipment present in the vicinity of the vehicle where the cyberattack occurred. Outputting the connection destination list to charging equipment in the vicinity of the vehicle where the cyberattack has occurred, and to which the cyberattack is likely to spread, makes it possible to suppress the spread of the cyberattack from that charging equipment.

Connection destination list distributor 51 may also output information indicating charging equipment capable of switching to communication with a charging management server included in the connection destination list (i.e., information indicating charging equipment that can be used by the vehicle where the cyberattack has occurred), for example. Through this, information indicating charging equipment capable of switching to communication with a charging management server to which cyberattacks are unlikely to spread is also output, and thus a vehicle where a cyberattack has occurred can charge using that charging equipment.

Connection destination list distributor 51 may also display the connection destination list on a display device, for example. Specifically, connection destination list distributor 51 may output the connection destination list not only to the charging equipment, but also to a smartphone or the like to be displayed therein. This enables an administrator of the charging equipment or the like to check the connection destination list.

As described above, charging equipment that charges a vehicle where a cyberattack has occurred can switch communication with a charging management server to communication with a charging management server through which cyberattacks will not spread even when communicating with a vehicle where a cyberattack has occurred (e.g., a server having strong security features or a server functioning as a honeypot), and the spread of cyberattacks can therefore be suppressed. For example, by using a connection destination list of charging management servers capable of connecting to a vehicle where a cyberattack has occurred, communication between a vehicle where a cyberattack has occurred and a charging management server managing charging equipment that charges that vehicle can easily be switched to communication with another charging management server through which cyberattacks are unlikely to spread.

### Other Embodiments

As described above, embodiments have been given as examples of the technique according to the present disclosure. However, the technique according to the present disclosure is not limited thereto, and can also be applied in embodiments in which modifications, replacements, additions, omissions, or the like have been made as appropriate. For example, variations such as those described below are also included in the embodiments of the present disclosure.

For example, although the foregoing embodiments described an example in which a risk value is calculated, the risk value does not necessarily have to be calculated. In other words, when a cyberattack is determined to have occurred at an edge, the communication information (specifically, the blacklist or the connection destination list) may be generated regardless of the risk value.

For example, the communication information may include information for transitioning charging equipment that charges a vehicle where a cyberattack has occurred to an offline mode. Transitioning the charging equipment to an offline mode when charging a vehicle where a cyberattack has occurred makes it possible to suppress the spread of the cyberattack.

For example, the present disclosure can be implemented not only as a charging support system, but also as a charging support method including steps (processes) performed by the constituent elements constituting the charging support system.

FIG. 7 is a flowchart illustrating an example of a charging support method according to another embodiment.

The charging support method includes: receiving a log sent from a vehicle or charging equipment (step S1); determining, based on the log, whether a cyberattack has occurred in the vehicle or the charging equipment (step S2); when a cyberattack is determined to have occurred in the vehicle or the charging equipment (YES in step S2), generating communication information indicating a communication method through which the cyberattack will not spread from the vehicle where the cyberattack has occurred, or a communication method through which the cyberattack will not spread from the charging equipment where the cyberattack has occurred (step S3); and outputting the communication information (step S4).

For example, the present disclosure can be implemented as a program for causing a computer (a processor) to execute the steps included in the charging support method. Furthermore, the present disclosure can be implemented as a non-transitory computer-readable recording medium, such as a CD-ROM, in which the program is recorded.

For example, when the present disclosure is implemented by a program (software), each step is performed by executing the program using hardware resources such as a CPU, memory, and input/output circuitry of the computer. In other words, each step is executed by the CPU obtaining data from the memory or input/output circuitry and performing computations, outputting computation results to the memory or the input/output circuitry, and the like.

In the foregoing embodiments, the constituent elements included in the charging support systems may be constituted by dedicated hardware, or the constituent elements may be realized by executing software programs corresponding to those constituent elements. Each constituent element may be realized by a program executing unit such as a CPU or a processor reading out and executing a software program recorded into a recording medium such as a hard disk or semiconductor memory.

Some or all of the functions of the charging support systems according to the foregoing embodiments are typically implemented as LSI circuits, which are integrated circuits. These devices can be implemented individually as single chips, or may be implemented with a single chip including some or all of the devices. Furthermore, the manner in which the circuit integration is achieved is not limited to LSI, and it is also possible to use a dedicated circuit or a generic processor. A Field Programmable Gate Array (FPGA) capable of post-production programming or a reconfigurable processor in which the connections and settings of the circuit cells within the LSI can be reconfigured may be used as well.

Furthermore, if other technologies that improve upon or are derived from semiconductor technology enable integration technology to replace LSI, then naturally it is also possible to use those technologies to create integrated circuits for the constituent elements included in the charging support systems.

Additionally, embodiments achieved by one skilled in the art making various conceivable variations on the embodiments, embodiments achieved by combining constituent elements and functions from the embodiments as desired within a scope which does not depart from the spirit of the present disclosure, and the like are also included in the present disclosure.

### Supplement

The following techniques are disclosed by the descriptions in the foregoing embodiments.

(Technique 1) A charging support system including: a log receiver that receives a log sent from a vehicle or charging equipment; an attack determiner that, based on the log, determines whether a cyberattack has occurred in the vehicle or the charging equipment; a generator that, when a cyberattack is determined to have occurred in the vehicle or the charging equipment, generates communication information indicating a communication method through which the cyberattack will not spread from the vehicle where the cyberattack has occurred, or a communication method through which the cyberattack will not spread from the charging equipment where the cyberattack has occurred; and an outputter that outputs the communication information.

Through this, communication information indicating a communication method through which the cyberattack will not spread is generated and distributed to the vehicle or charging equipment managed by the charging support system. Accordingly, the vehicle or the charging equipment that obtains the communication information can charge using the communication method through which the cyberattack will not spread. The spread of cyberattacks can therefore be suppressed when charging a vehicle from charging equipment.

(Technique 2) The charging support system according to Technique 1, wherein when the attack determiner determines that the cyberattack has occurred, the attack determiner calculates a risk value indicating a magnitude of a risk the cyberattack poses to an other vehicle or other charging equipment, and the generator generates the communication information when the risk value is at least a threshold.

Through this, if the risk value of the cyberattack is low, it is unlikely to be a problem even if the cyberattack spreads, and the communication information is therefore not generated. In other words, if the risk value is low, a charging service can be provided as normal.

(Technique 3) The charging support system according to Technique 1 or 2, wherein the communication information is information indicating a communication method that prohibits communication between the vehicle where the cyberattack has occurred and charging equipment that charges the vehicle, or communication between the charging equipment where the cyberattack has occurred and a vehicle to be charged by the charging equipment.

Through this, communication between a vehicle where a cyberattack has occurred and charging equipment that charges that vehicle, or communication between charging equipment where a cyberattack has occurred and a vehicle charged by that charging equipment, is prohibited, and the spread of the cyberattack can therefore be suppressed.

(Technique 4) The charging support system according to Technique 3, wherein the communication information is a blacklist of one or more vehicles or charging equipment with which communication is to be prohibited, the blacklist including the vehicle where the cyberattack has occurred or the charging equipment where the cyberattack has occurred.

Through this, using a blacklist of vehicles or charging equipment makes it possible to ensure that communication between a vehicle where a cyberattack has occurred and charging equipment that charges that vehicle, or communication between charging equipment where a cyberattack has occurred and a vehicle charged by that charging equipment, is not performed.

(Technique 5) The charging support system according to Technique 4, wherein the generator adds an other vehicle or other charging equipment to the blacklist based on an attack occurrence time or an attack factor indicated by the log obtained from the vehicle where the cyberattack has occurred or the charging equipment where the cyberattack has occurred.

Through this, charging equipment or vehicles presumed to have been affected can be added to the blacklist in bulk.

(Technique 6) The charging support system according to Technique 4 or 5, wherein the outputter further outputs information indicating charging equipment not included in the blacklist.

Through this, information indicating charging equipment not included in the blacklist, i.e., charging equipment where a cyberattack has not occurred, is also output, which enables vehicles to charge using normal charging equipment.

(Technique 7) The charging support system according to any one of Techniques 3 to 6, wherein the communication information further includes a factor of the cyberattack.

Through this, a factor of the cyberattack can be ascertained.

(Technique 8) The charging support system according to any one of Techniques 3 to 7, wherein the outputter outputs the communication information to a vehicle or charging equipment present in a vicinity of the vehicle where the cyberattack has occurred or the charging equipment where the cyberattack has occurred.

Through this, outputting communication information to vehicles or charging equipment in the vicinity of the vehicle or charging equipment where the cyberattack has occurred, and to which the cyberattack is likely to spread, makes it possible to suppress the spread of the cyberattack to those vehicles or charging equipment.

(Technique 9) The charging support system according to Technique 1 or 2, wherein the communication information is information indicating a communication method that switches communication from communication between the vehicle where the cyberattack has occurred and a charging management server managing charging equipment that charges the vehicle to communication with an other charging management server.

Through this, charging equipment that charges a vehicle where a cyberattack has occurred can switch communication with the charging management server to communication with a charging management server through which cyberattacks will not spread even when communicating with a vehicle where a cyberattack has occurred, and the spread of cyberattacks can therefore be suppressed.

(Technique 10) The charging support system according to Technique 9, wherein the communication information is a list of one or more charging management servers, among charging management servers managing charging equipment that charges the vehicle where the cyberattack has occurred, that are connectable to the vehicle where the cyberattack has occurred.

Through this, by using a list of charging management servers capable of connecting to a vehicle where a cyberattack has occurred, communication between a vehicle where a cyberattack has occurred and a charging management server managing charging equipment that charges that vehicle can easily be switched to communication with another charging management server through which cyberattacks are unlikely to spread.

(Technique 11) The charging support system according to Technique 10, wherein the outputter further outputs information indicating charging equipment switchable to communication with a charging management server included in the list.

Through this, information indicating charging equipment capable of switching to communication with a charging management server to which cyberattacks are unlikely to spread is also output, and thus a vehicle where a cyberattack has occurred can charge using that charging equipment.

(Technique 12) The charging support system according to any one of Techniques 9 to 11, wherein the outputter outputs the communication information to charging equipment present in a vicinity of the vehicle where the cyberattack has occurred.

Through this, outputting communication information to charging equipment in the vicinity of the vehicle where the cyberattack has occurred, and to which the cyberattack is likely to spread, makes it possible to suppress the spread of the cyberattack from that charging equipment.

(Technique 13) The charging support system according to any one of Techniques 1 to 12, wherein the communication information includes information for transitioning charging equipment that charges the vehicle where the cyberattack has occurred to an offline mode.

Through this, transitioning the charging equipment to an offline mode when charging a vehicle where a cyberattack has occurred makes it possible to suppress the spread of the cyberattack.

(Technique 14) The charging support system according to any one of Technique 1 to 13, wherein when the communication information is requested by a vehicle or charging equipment, the outputter outputs the communication information to the vehicle or the charging equipment.

Through this, the vehicle or charging equipment to which the communication information has not yet been distributed can obtain the communication information by making a request for the communication information to the charging support system.

(Technique 15) The charging support system according to any one of Techniques 1 to 14, wherein the charging equipment is equipment that charges over a wire, equipment that charges wirelessly, or a dynamic power supply system.

In this manner, the charging equipment may be equipment that charges over a wire, equipment that charges wirelessly, or a dynamic power supply system.

(Technique 16) The charging support system according to any one of Techniques 1 to 15, wherein the outputter displays the communication information in a display device.

Through this, an occupant of the vehicle, an administrator of the charging equipment, or the like can check the communication information.

(Technique 17) A charging support method includes: receiving a log sent from a vehicle or charging equipment; determining, based on the log, whether a cyberattack has occurred in the vehicle or the charging equipment; when a cyberattack is determined to have occurred in the vehicle or the charging equipment, generating communication information indicating a communication method through which the cyberattack will not spread from the vehicle where the cyberattack has occurred, or a communication method through which the cyberattack will not spread from the charging equipment where the cyberattack has occurred; and outputting the communication information.

Through this, a charging support method that can suppress the spread of cyberattacks when charging a vehicle from charging equipment can be provided.

### Further Information about Technical Background to this Application

The disclosure of the following patent application including specification, drawings, and claims is incorporated herein by reference in its entirety: Japanese Patent Application No. 2025-029366 filed on Feb. 26, 2025.

### Industrial Applicability

The present disclosure can be applied in a system or the like that manages a vehicle and charging equipment.

1. A charging support system comprising:
a log receiver that receives a log sent from a vehicle or charging equipment;
an attack determiner that, based on the log, determines whether a cyberattack has occurred in the vehicle or the charging equipment;
a generator that, when a cyberattack is determined to have occurred in the vehicle or the charging equipment, generates communication information indicating a communication method through which the cyberattack will not spread from the vehicle where the cyberattack has occurred, or a communication method through which the cyberattack will not spread from the charging equipment where the cyberattack has occurred; and
an outputter that outputs the communication information.

2. The charging support system according to claim 1,
wherein when the attack determiner determines that the cyberattack has occurred, the attack determiner calculates a risk value indicating a magnitude of a risk the cyberattack poses to an other vehicle or other charging equipment, and
the generator generates the communication information when the risk value is at least a threshold.

3. The charging support system according to claim 1,
wherein the communication information is information indicating a communication method that prohibits communication between the vehicle where the cyberattack has occurred and charging equipment that charges the vehicle, or communication between the charging equipment where the cyberattack has occurred and a vehicle to be charged by the charging equipment.

4. The charging support system according to claim 3,
wherein the communication information is a blacklist of one or more vehicles or charging equipment with which communication is to be prohibited, the blacklist including the vehicle where the cyberattack has occurred or the charging equipment where the cyberattack has occurred.

5. The charging support system according to claim 4,
wherein the generator adds an other vehicle or other charging equipment to the blacklist based on an attack occurrence time or an attack factor indicated by the log obtained from the vehicle where the cyberattack has occurred or the charging equipment where the cyberattack has occurred.

6. The charging support system according to claim 4,
wherein the outputter further outputs information indicating charging equipment not included in the blacklist.

7. The charging support system according to claim 3,
wherein the communication information further includes a factor of the cyberattack.

8. The charging support system according to claim 3,
wherein the outputter outputs the communication information to a vehicle or charging equipment present in a vicinity of the vehicle where the cyberattack has occurred or the charging equipment where the cyberattack has occurred.

9. The charging support system according to claim 1,
wherein the communication information is information indicating a communication method that switches communication from communication between the vehicle where the cyberattack has occurred and a charging management server managing charging equipment that charges the vehicle to communication with an other charging management server.

10. The charging support system according to claim 9,
wherein the communication information is a list of one or more charging management servers, among charging management servers managing charging equipment that charges the vehicle where the cyberattack has occurred, that are connectable to the vehicle where the cyberattack has occurred.

11. The charging support system according to claim 10,
wherein the outputter further outputs information indicating charging equipment switchable to communication with a charging management server included in the list.

12. The charging support system according to claim 9,
wherein the outputter outputs the communication information to charging equipment present in a vicinity of the vehicle where the cyberattack has occurred.

13. The charging support system according to claim 1,
wherein the communication information includes information for transitioning charging equipment that charges the vehicle where the cyberattack has occurred to an offline mode.

14. The charging support system according to claim 1,
wherein when the communication information is requested by a vehicle or charging equipment, the outputter outputs the communication information to the vehicle or the charging equipment.

15. The charging support system according to claim 1,
wherein the charging equipment is equipment that charges over a wire, equipment that charges wirelessly, or a dynamic power supply system.

16. The charging support system according to claim 1,
wherein the outputter displays the communication information in a display device.

17. A charging support method comprising:
receiving a log sent from a vehicle or charging equipment;
determining, based on the log, whether a cyberattack has occurred in the vehicle or the charging equipment;
when a cyberattack is determined to have occurred in the vehicle or the charging equipment, generating communication information indicating a communication method through which the cyberattack will not spread from the vehicle where the cyberattack has occurred, or a communication method through which the cyberattack will not spread from the charging equipment where the cyberattack has occurred; and
outputting the communication information.
